(19) United States
(12) Patent Application Publication
(10) Pub. No.: US 2024/0248906 A1
(43) Pub. Date: Jul. 25, 2024

(54) INTAKE TRANSFORMATION SYSTEMS

(71) Applicant: Ignite IPA, Sayville, NY (US)

(72) Inventors: Arun Muthuraj VEDAMANICKAM, Chennai (IN); Ramesh SELVARAJ, New Hartford, NY (US); Akshay JINDAM, Pune (IN); Manisha PURWANI, Chandrapur (IN); Mark Shivers, Sayville, NY (US)

(21) Appl. No.: 18/413,490

(22) Filed: Jan. 16, 2024

Related U.S. Application Data
(60) Provisional application No. 63/439,952, filed on Jan. 19, 2023.

(51) Int. Cl. G06F 16/25

(52) U.S. Cl. CPC G06F 16/254

(57) ABSTRACT

A system for intake transformation includes a processor and a memory coupled to the processor. The memory storing instructions which, when executed by the processor, cause the system to: access a document that includes content, metadata, and a predetermined ID; extract data based on parsing; transform the data based on a predetermined set of rules; apply one or more rules to the transformed data; generate a request for a workflow based on the transformed data and further based on a target workflow platform; receive a response from the target workflow platform, using an API to communicate with the target workflow platform; determine completion of the workflow based on the response; and transmit an alert based on the completion of the workflow.

### CROSS-REFERENCE TO RELATED APPLICATIONS

This application claims the benefit of U.S. Provisional Patent Application No. 63/439,952, filed on Jan. 19, 2023, the entire contents of which are hereby incorporated herein by reference.

### TECHNICAL FIELD

The present application relates to intake transformation systems and, in particular, to data ingestion and intelligent workflows.

### SUMMARY

In accordance with aspects of the present disclosure, a system for intake transformation includes a processor and a memory coupled to the processor. The memory includes instructions which, when executed by the processor, cause the system to access a document including content, metadata, and a predetermined ID; extract data based on parsing; transform the data based on a predetermined set of rules; apply one or more rules to the transformed data; generate a request for a workflow based on the transformed data and further based on a target workflow platform; receive a response from the target workflow platform, using an API to communicate with the target workflow platform; determine completion of the workflow based on the response; and transmit an alert based on the completion of the workflow.

In an aspect of the present disclosure, the instructions, when executed by the processor, may further cause the system to log the completed workflow based on the completion of the workflow.

In an aspect of the present disclosure, the instructions, when executed by the processor, may further cause the system to authenticate the generated request based on the predetermined ID.

In another aspect of the present disclosure, the predetermined ID may be associated with a format defined in a configuration file.

In yet another aspect of the present disclosure, the document may further include an image.

In a further aspect of the present disclosure, the instructions, when executed by the processor, may further cause the system to extract the image and compress the image without reducing the quality of the image.

In yet a further aspect of the present disclosure, the instructions, when executed by the processor, may further cause the system to determine that the content includes a recipient address, a sender address, a subject, a date received, and/or a time received. The generated request for the workflow is further based on the recipient address, the sender address, the subject, the date received, and/or the time received.

In another aspect of the present disclosure, the instructions, when executed by the processor, may further cause the system to store third-party API credentials and endpoints.

In yet another aspect of the present disclosure, the system may be configured to perform the instructions as parallel threads.

In an aspect of the present disclosure, the instructions, when executed by the processor, may further cause the system to disable the one or more rules.

In accordance with aspects of the present disclosure, a computer-implemented method for intake transformation includes accessing a document that includes structured data and unstructured data, and extracting data based on parsing. The data further includes content, metadata, and a predetermined ID. The method further includes transforming the data based on a predetermined set of rules; applying one or more rules to the transformed data; generating a request for a workflow based on the transformed data and further based on a target workflow platform; receiving a response from the target workflow platform, using an API to communicate with the target workflow platform; determining completion of the workflow based on the response; and transmitting an alert based on the completion of the workflow.

In an aspect of the present disclosure, the method may further include logging the completed workflow based on the completion of the workflow.

In another aspect of the present disclosure, the method may further include authenticating the generated request based on the predetermined ID.

In yet another aspect of the present disclosure, the predetermined ID may be associated with a format defined in a configuration file.

In a further aspect of the present disclosure, the document may further include an image.

In yet a further aspect of the present disclosure, the method may further include extracting the image and compressing the image without reducing the quality of the image.

In an aspect of the present disclosure, the method may further include determining that the content includes a recipient address, a sender address, a subject, a date received, and/or a time received. The generated request for the workflow may be further based on the recipient address, the sender address, the subject, the date received, and/or the time received.

In another aspect of the present disclosure, the method may further include storing third-party API credentials and endpoints.

In yet another aspect of the present disclosure, the method may further include performing the transforming as parallel threads.

In accordance with aspects of the present disclosure, a non-transitory computer-readable storage medium storing a program that causes a computer to execute a computer-implemented method of intake transformation is presented. The method includes accessing a document that includes structured data and unstructured data and extracting data based on parsing. The data further includes content, metadata, and/or a predetermined ID. The method further includes transforming the data based on a predetermined set of rules; applying one or more rules to the transformed data; generating a request for a workflow based on the transformed data and further based on a target workflow platform; receiving a response from the target workflow platform, using an API to communicate with the target workflow platform; determining completion of the workflow based on the response; and transmitting an alert based on the completion of the workflow.

Further details and aspects of exemplary embodiments of the present disclosure are described in more detail below with reference to the appended figures.

### BRIEF DESCRIPTION OF THE DRAWINGS

A better understanding of the features and advantages of the disclosed technology will be obtained by reference to the following detailed description that sets forth illustrative embodiments, in which the principles of the technology are utilized, and the accompanying drawings of which:

FIG. 1 is a network diagram illustration showing an exemplary system for a computer-implemented method for document intake transformation in accordance with aspects of the present disclosure;

FIG. 2 is a block diagram of a controller for machine learning-based recommendations in accordance with aspects of the present disclosure;

FIG. 3 is a flow diagram of an exemplary method for using the networked environment of FIG. 1 in accordance with aspects of the present disclosure;

FIG. 4 is a flow diagram for an example business scenario in accordance with the present disclosure;

FIG. 5 is a flow diagram of an example data flow in accordance with the present disclosure;

FIGS. 6-8 are example flow diagrams for the system of FIG. 1, in accordance with the present disclosure;

FIG. 9 is an example flow diagram of business logic for the system of FIG. 1, in accordance with the present disclosure; and

FIG. 10 is a block diagram of users and external connectors interacting with the system of FIG. 1, in accordance with the present disclosure.

### DETAILED DESCRIPTION

The present application relates to systems and methods for document intake transformation.

For purposes of promoting an understanding of the principles of the present disclosure, reference will now be made to exemplary embodiments illustrated in the drawings, and specific language will be used to describe the same. It will nevertheless be understood that no limitation of the scope of the present disclosure is thereby intended. Various alterations, rearrangements, substitutions, and modifications of the inventive features illustrated herein, and any additional applications of the principles of the present disclosure as illustrated herein, which would occur to one skilled in the relevant art and having possession of this disclosure, are to be considered within the scope of the present disclosure.

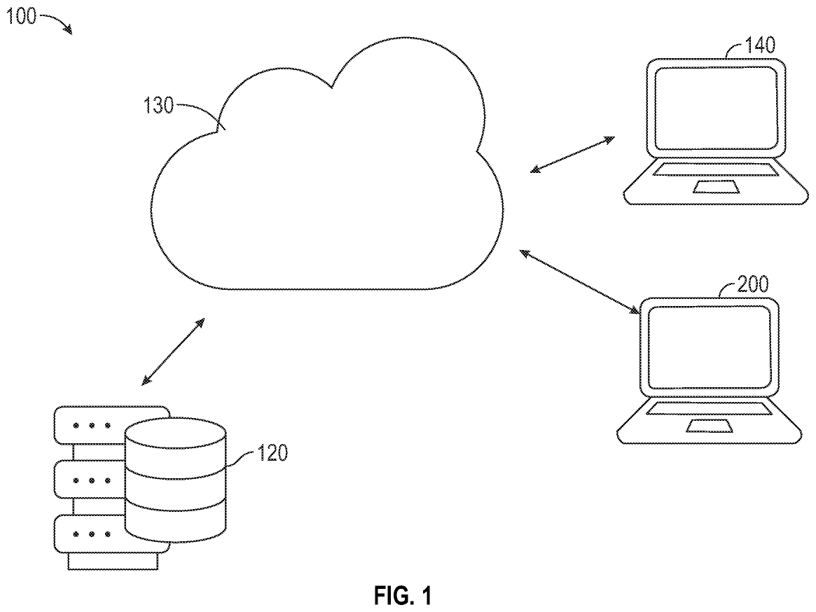

Referring to FIG. 1, an exemplary system 100, in accordance with aspects of the present disclosure, includes a controller 200. It is contemplated that the controller 200 may run programs locally on the controller 200, remotely via a network 130, over the cloud, and/or on a remote server 120. The controller 200 may include, but is not limited to, a mobile phone, a personal computer, a tablet, and/or other handheld device.

The network 130 may be wired or wireless and can utilize technologies such as Wi-Fi®, Ethernet, Internet Protocol, 3G, 4G, 5G, TDMA, CDMA, or other communication technologies. The network 150 may include, for example, but is not limited to, a cellular network, residential broadband, satellite communications, private network, the Internet, local area network, wide area network, storage area network, campus area network, personal area network, or metropolitan area network.

The term “application” may include a computer program and/or machine-readable instructions designed to perform particular functions, tasks, or activities for the benefit of a user. Application may refer to, for example, software running locally or remotely, as a standalone program or in a web browser, or other software that would be understood by one skilled in the art to be an application. An application may run on the controller 200, a server, a user device 140, or a client computer system. The configuration of FIG. 1 is exemplary, and variations are contemplated to be within the scope of the present disclosure.

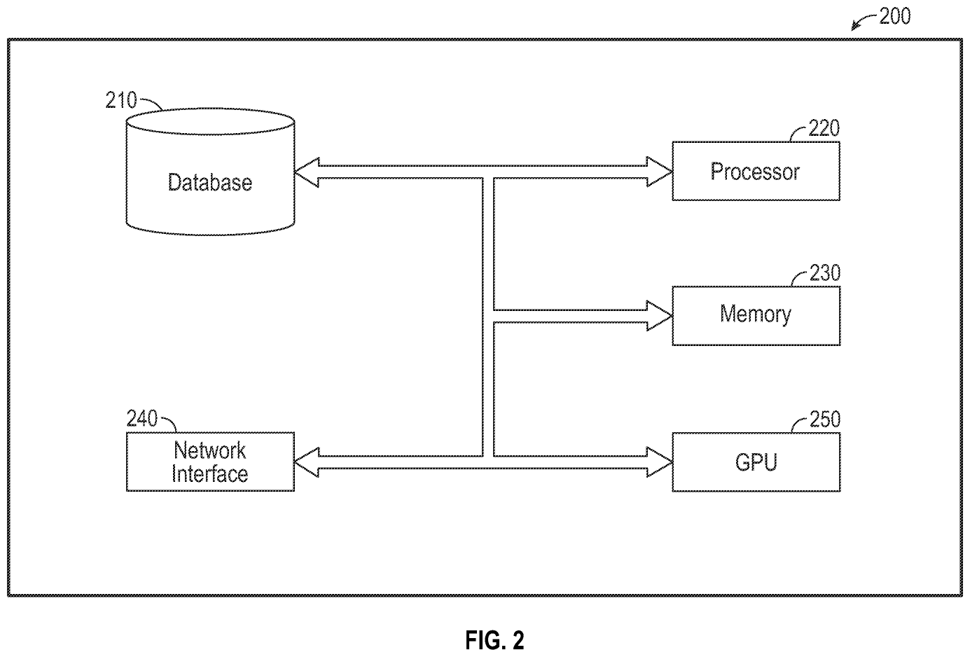

Referring now to FIG. 2, exemplary components in the controller 200 include, for example, a database 210, one or more processors 220, at least one memory 230, and a network interface 240. In aspects, the controller 200 may include a graphical processing unit (GPU) 250, which may be used for processing machine learning models.

The database 210 can be located in storage. The term “storage” may refer to any device or material from which information may be capable of being accessed, reproduced, and/or held in an electromagnetic or optical form for access by a computer processor. Storage may be, for example, volatile memory such as RAM, non-volatile memory, which permanently holds digital data until purposely erased, such as flash memory, magnetic devices such as hard disk drives, and optical media such as a CD, DVD, Blu-ray disc, or the like.

In various embodiments, data may be stored on the controller 200, including, for example, user preferences, historical data, and/or other data. The data can be stored in the database 210 and sent via the system bus to the processor 220.

As will be described in more detail later herein, the processor 220 executes various processes based on instructions that can be stored in the server memory 230 and utilizing the data from the database 210. With reference also to FIG. 1, a request from a user device, such as a mobile device or a client computer, can be communicated to the server through the server's network interface 240. The illustration of FIG. 2 is exemplary, and persons skilled in the art will understand that other components, such as an input device and/or a display may exist in controller 200. Such other components are not illustrated in FIG. 2 for clarity.

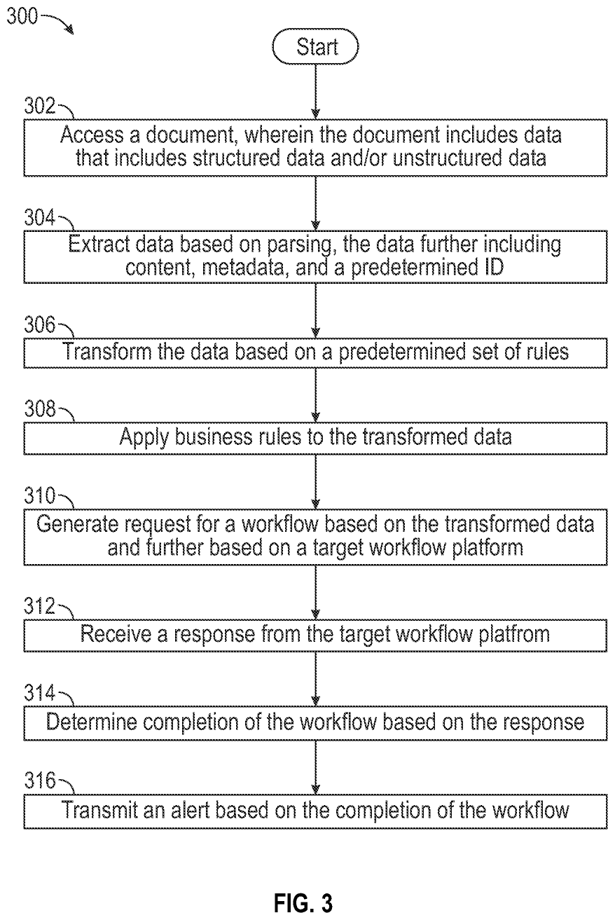

FIG. 3 shows a block diagram for an exemplary method for document intake transformation. Although the steps of FIG. 3 are shown in a particular order, the steps need not all be performed in the specified order, and certain steps can be performed in any suitable order. For example, FIG. 3 will be described below, with a server (e.g., controller 200 of FIG. 2) performing the operations. In various aspects, the operations of FIG. 3 may be performed, all or in part, by the controller 200 of FIG. 1. In aspects, the operations of FIG. 3 may be performed, all or in part, by another device, for example, a mobile device and/or a client computer system.

The disclosed technology provides the benefits of a simple installer that enables easy installation of the system. The installer establishes the system in in-house systems, such as ERP systems. The method 300 (FIG. 3) can manage any business data in an in-house network. The disclosed technology provides the benefit of multiple environment configurations. The system 100 may be configured for different parameters and/or environments, such as development, testing, and production environments.

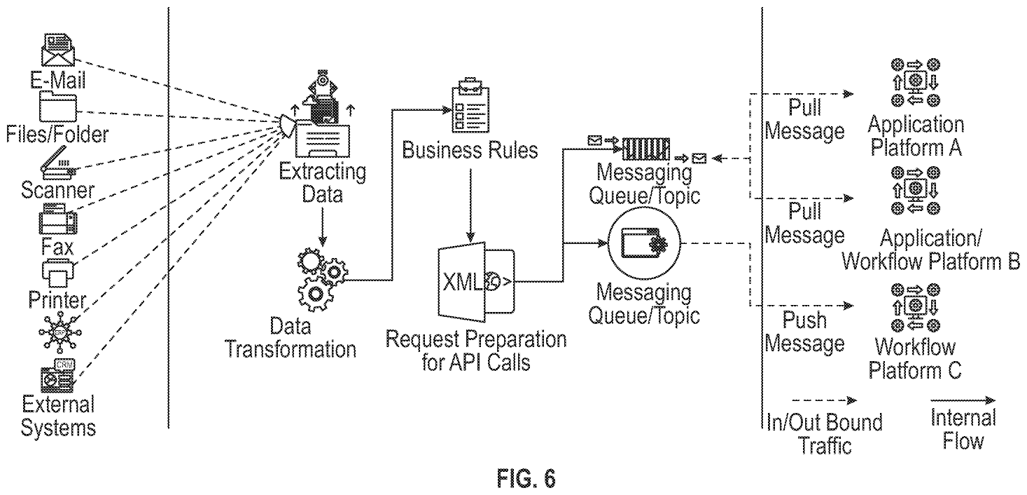

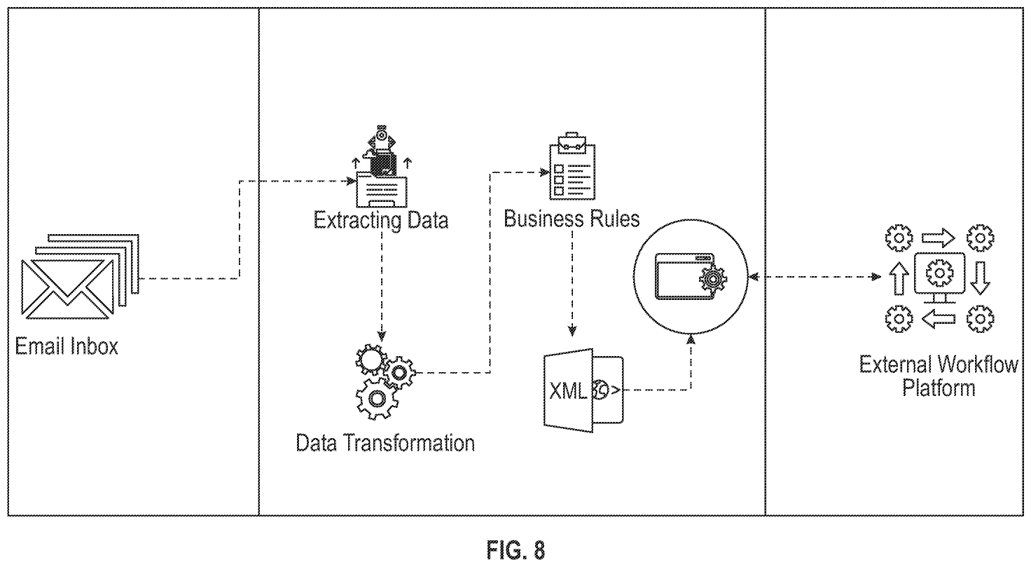

Initially, at step 302, the controller 200 causes the system 100 to access a document for ingestion and transformation. The document may include structured data and/or unstructured data. The document may include, for example, email, word files, PDF, and/or scanned documents (which may be subject to optical character recognition (OCR)) (FIGS. 6-8). In aspects, the document may include data from external systems, such as from a CRM and/or an ERP system. The data may include content, metadata, and/or a predetermined ID. The content may include a recipient address, a sender address, a subject, a date received, and/or a time received. The metadata may include, for example, author, date created, date modified, and/or file size.

Multiple email accounts may be configured via a configuration file fed into a single workflow. One or more documents may be accessed at the same time. In aspects, the system may include a configuration option to set a maximum number of emails that each iteration can access. In aspects, the system may include a setting to configure a time interval between each iteration of ingesting and transforming data. For example, the document may include a customer request email.

Next, at step 304, the controller 200 causes the system 100 to extract data based on parsing. The data may include content, metadata, and/or a predetermined ID. For example, an ID may be extracted from an email based on a predefined format. Although email is used as an example, other electronic communication medium such as instant messaging apps, video calls, phone calls, blogs, and/or text messages is contemplated. For example, the controller 200 may cause the system 100 to extract an image attached to an email and compress the image (e.g., without reducing the quality of the image). The controller 200 may cause the system 100 to extract data based on natural language processing. In aspects, the controller 200 may cause the system 100 to extract data based on optical character recognition, database querying, API integrations, web scraping, data mining, and/or text pattern matching.

For example, the customer request email may be ingested, and a customer ID and an order quantity may be extracted. An ID creation date may be checked.

Next, at step 306, the controller 200 causes the system 100 to transform the data based on a predetermined set of rules. For example, the transformed data may be parsed and then mapped to specific processes.

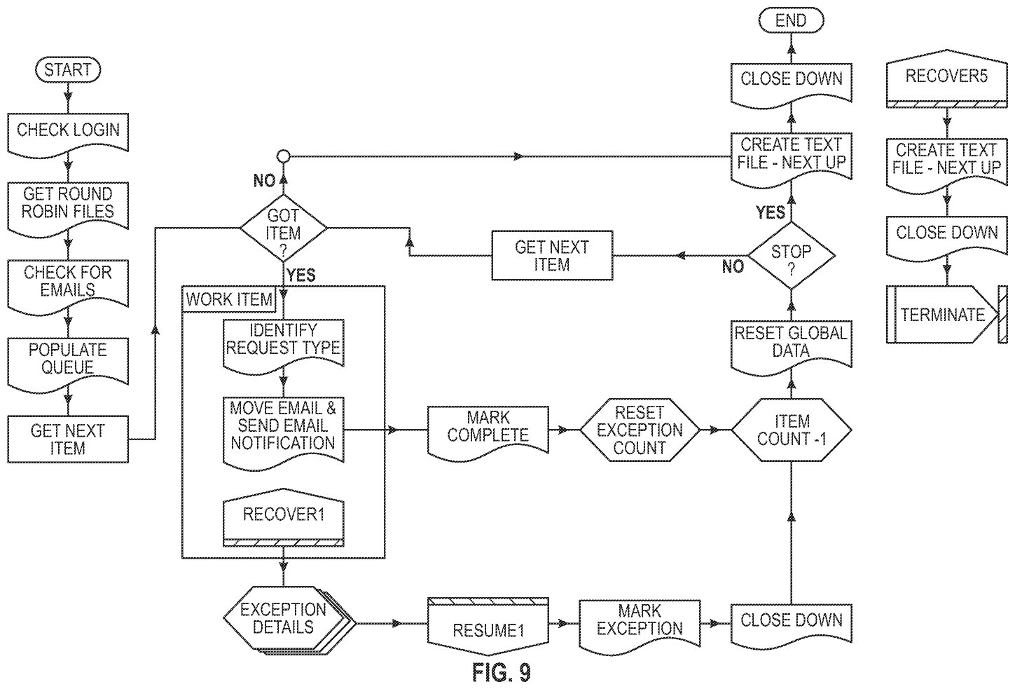

Next, at step 308, the controller 200 causes the system 100 to apply one or more rules (e.g., business rules) to the transformed data. Common business logic may be added to the system in a modular format (FIG. 9). In aspects, the one or more rules may be enabled and/or disabled. The controller 200 causes the system 100 to convert the data to XML for communicating with a target workflow platform (FIG. 6-8).

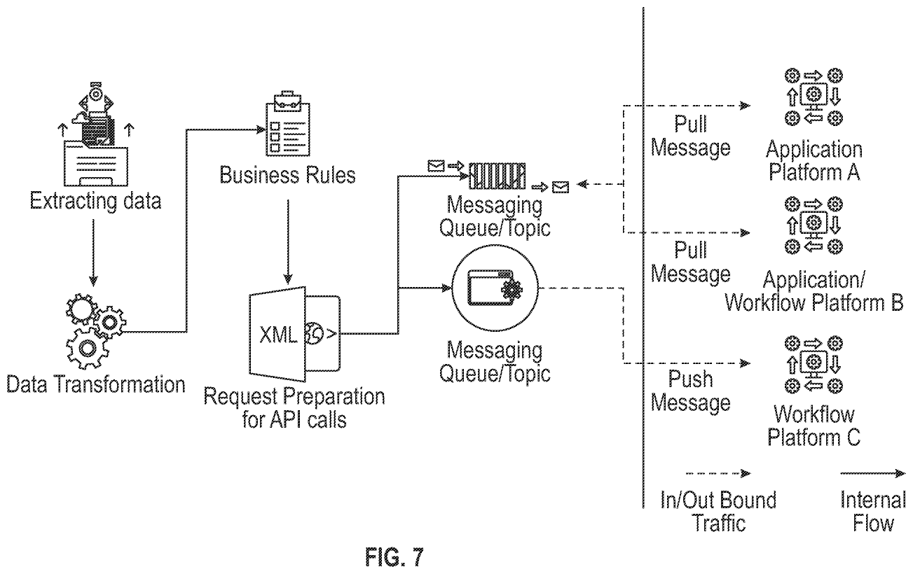

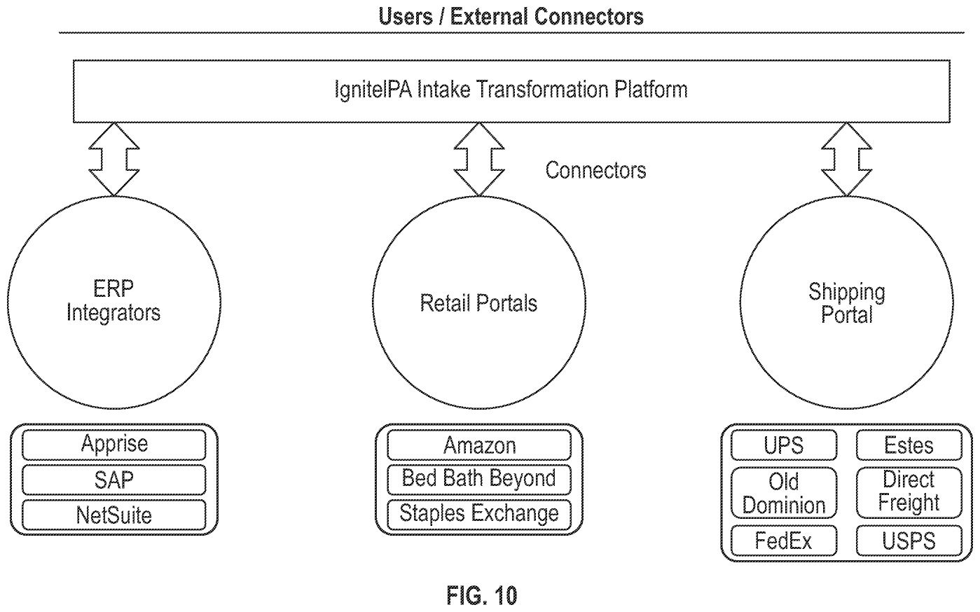

In aspects, the controller 200 causes the system 100 to prepare messages (e.g., email) based on the transformed data (FIGS. 6 and 7) for communicating with one or more target workflow platforms. The target platforms may include, for example, an enterprise resource planning system (FIG. 10).

Next, at step 310, the controller 200 causes the system 100 to generate a request for a workflow based on the transformed data and further based on the target workflow platform. For example, the request may include a parts order or an order to ship a completed item to a specific customer.

In aspects, the controller 200 may cause the system 100 to authenticate the generated request based on the predetermined ID. In aspects, the controller 200 may cause the system 100 to store credentials such as third-party API credentials and/or end points. The credentials may be stored in an encrypted format. Once authenticated, the controller 200 may cause the system 100 to transmit the processed data to the target workflow platform.

Next, at step 312, the controller 200 causes the system 100 to receive a response from the target workflow platform, using an API to communicate with the target workflow platform. The response may include the status of the workflow, such as workflow completion, or acceptance of the workflow request.

For example, the target workflow platform, based on the request for a workflow, may check inventory and check charges such as shipping charges. The target workflow platform may calculate the charges and the details of the request and pass the information back to system 100. The controller 200 may cause the system 100 to invoke the target workflow platform to ship the products.

Next, at step 314, the controller 200 causes the system 100 to determine the completion of the workflow based on the response.

For example, the response may include an indication that the products were shipped and/or an invoice was generated.

Next, at step 316, the controller 200 causes the system 100 to transmit an alert based on the completion of the workflow. For example, an end user may receive a text or an email from the system 100 as an alert indicating that the order was completed and/or the products were shipped.

In aspects, the controller 200 may cause the system 100 to log the completed workflow based on the completion of the workflow. The system 100 is configured to perform the instructions as parallel threads. For example, multiple workflows may operate in parallel, thus providing the benefit of reducing the time taken to consume the documents.

The disclosed system 100 solves the technical problem of disparate systems not communicating in a manufacturing or distribution environment by transforming data such as documents and parsing the transformed data in a way that the system can determine if a workflow was completed or not based on the parsed, transformed data. This enables the generation of invoices and/or alerts.

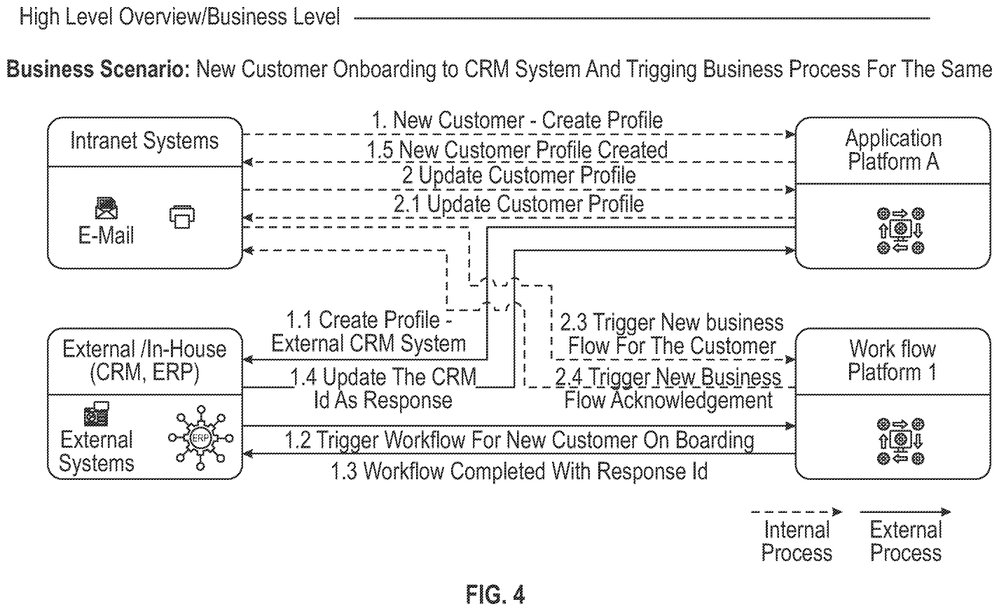

Referring to FIG. 4, a flow diagram for an example business scenario with customer onboarding for the system of FIG. 1 is provided. The system 100 may be utilized to work with a target workflow platform such as a customer relationship management (CRM) system or an enterprise resource planning (ERP) system. Initially, a new customer creates a profile, which is communicated to Application Platform A. Documents from the intranet systems, such as emails and/or scanned documents, may be ingested and transformed via step 304 of the method of FIG. 3, and the resulting transformed data triggers a new business flow for the customer. The new business flow may be communicated to Workflow Platform 1, which may respond with an acknowledgment.

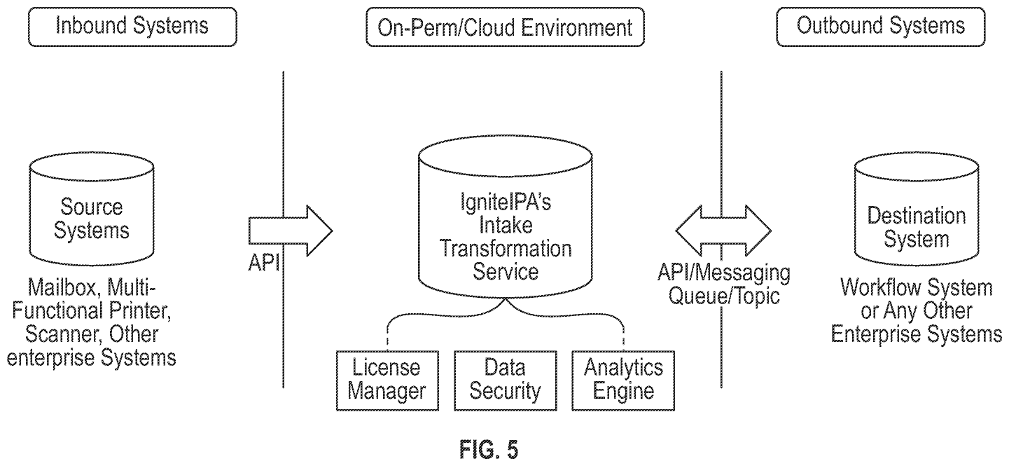

Referring to FIG. 5, a flow diagram of an example data flow of the system of FIG. 1 is shown. Inbound systems, such as mailboxes, multifunction printers, scanners, and/or other enterprise systems, provide documents as input to the system 100. The system 100 provides license management, data security, and an analytics engine for processing the documents and transmitting the transformed data to the target workflow platform.

Referring to FIGS. 6-8, some example scenarios are described below. For example, based on the scanned document's content, a case can be created in a CRM or ERP system, or an email will be triggered to the customer or team (FIG. 6). Based on the request from the CRM or ERP system, the system 100 (FIG. 1) may transform the data and apply business rules to trigger a request to the external retail or shipping portals. Communication with the CRM or ERP system may be performed using an API. When a new order is received from a retail portal, the portal triggers a request to intake solution, which in turn checks for the availability of the product in the CRM or ERP system, and based on the availability, it triggers a request to the accounting tool for recording the order details. With the built-in scheduler in place, the system 100 continuously triggers the request to the shipping portal based on the orders in the CRM system to get the latest update and share it with the user.

In another exemplary scenario, the scanner flow is described. For example, system 100 may continuously monitor a folder location that would consume the file. When a document is scanned, the scanned copy will be saved in the shared drive. The system 100 may then parse the scanned documents and may also assign a tracking ID. The system 100 is configured to understand and classify the document based on the predefined rules based on a properties file configuration. The system 100 may apply the necessary transformation based on the predefined rules. Once the above process is completed, system 100 may prepare the request to trigger the request for upstream workflow, which can be a wide range of systems like ERM, CRM, and other web portals.

In another exemplary scenario, the CRM flow is described. A logical connector is built for the intake engine with the CRM system. The system 100 may continuously query the CRM system based on the configuration set in the properties file for the new lead or case that was created. When the system 100 finds a new case/lead, it extracts the metadata and the information about the case/lead. Data transformation logic may be applied by the system 100 to the extracted content to match the standards of the intake platform. Business logic may be applied by the system 100 to the extracted data to classify and categorize the content. The system 100 builds a request based on the extracted information identified in the above step. Once the request is ready, system 100 triggers the request to the downstream workflow, which can be a wide range of systems like ERM, CRM, and various other web portals.

FIG. 10 is a block diagram of users and external connectors interacting with the system of FIG. 1, in accordance with the present disclosure. The system 100 is configured to communicate with external platforms, such as ERP integrators, retail portals, and/or shipping portals.

The embodiments disclosed herein are examples of the disclosure and may be embodied in various forms. For instance, although certain embodiments herein are described as separate embodiments, each of the embodiments herein may be combined with one or more of the other embodiments herein. Specific structural and functional details disclosed herein are not to be interpreted as limiting, but as a basis for the claims and as a representative basis for teaching one skilled in the art to employ the present disclosure in virtually any appropriately detailed structure in various ways. Like reference numerals may refer to similar or identical elements throughout the description of the figures.

The phrases “in an embodiment,” “in embodiments,” “in various embodiments,” “in some embodiments,” or “in other embodiments” may each refer to one or more of the same or different embodiments in accordance with the present disclosure. A phrase in the form “A or B” means “(A), (B), or (A and B).” A phrase in the form “at least one of A, B, or C” means “(A); (B); (C); (A and B); (A and C); (B and C); or (A, B, and C).”

Any of the herein-described methods, programs, algorithms, or codes may be converted to or expressed in a programming language or computer program. The terms “programming language” and “computer program,” as used herein, each include any language used to specify instructions to a computer, and include (but is not limited to) the following languages and their derivatives: Assembler, Basic, Batch files, BCPL, C, C+, C++, Delphi, Fortran, Java, JavaScript, machine code, operating system command languages, Pascal, Perl, PL1, scripting languages, Visual Basic, metalanguages which themselves specify programs, and all first, second, third, fourth, fifth, or further generation computer languages. Also included are database and other data schemas, and any other meta-languages. No distinction is made between languages that are interpreted, compiled, or use both compiled and interpreted approaches. No distinction is made between compiled and source versions of a program. Thus, reference to a program, where the programming language could exist in more than one state (such as source, compiled, object, or linked) is a reference to any and all such states. Reference to a program may encompass the actual instructions and/or the intent of those instructions.

It should be understood the foregoing description is only illustrative of the present disclosure. Various alternatives and modifications can be devised by those skilled in the art without departing from the disclosure. Accordingly, the present disclosure is intended to embrace all such alternatives, modifications, and variances. The embodiments described with reference to the attached drawing figures are presented only to demonstrate certain examples of the disclosure. Other elements, steps, methods, and techniques that are insubstantially different from those described above are also intended to be within the scope of the disclosure.

What is claimed is:

1. A system for intake transformation comprising:
a processor; and
a memory coupled to the processor and storing instructions which, when executed by the processor, cause the system to:
access a document, wherein the document includes data, wherein the data includes content, metadata, and a predetermined ID;
extract the data based on parsing, the data further including;
transform the data based on a predetermined set of rules;
apply one or more rules to the transformed data;
generate a request for a workflow based on the transformed data and further based on a target workflow platform;
receive a response from the target workflow platform, using an API to communicate with the target workflow platform;
determine completion of the workflow based on the response; and
transmit an alert based on the completion of the workflow.

2. The system of claim 1, wherein the instructions, when executed by the processor, further cause the system to log the completed workflow based on the completion of the workflow.

3. The system of claim 1, wherein the instructions, when executed by the processor, further cause the system to authenticate the generated request based on the predetermined ID.

4. The system of claim 1, wherein the predetermined ID is associated with a format defined in a configuration file.

5. The system of claim 1, wherein the document further includes an image.

6. The system of claim 5, wherein the instructions, when executed by the processor, further cause the system to:
extract the image; and
compress the image without reducing a quality of the image.

7. The system of claim 1, wherein the instructions, when executed by the processor, further cause the system to:
determine that the content includes a recipient address, a sender address, a subject, a date received, and/or a time received,
wherein the generated request for the workflow is further based on the recipient address, the sender address, the subject, the date received, and/or the time received.

8. The system of claim 1, wherein the instructions, when executed by the processor, further cause the system to store third-party API credentials and endpoints.

9. The system of claim 1, wherein the system is configured to perform the instructions as parallel threads.

10. The system of claim 1, wherein the instructions, when executed by the processor, further cause the system to disable the one or more rules.

11. A computer-implemented method for intake transformation comprising:
accessing a document, wherein the document includes data, wherein the data includes content, metadata, and a predetermined ID;
extracting data based on parsing;
transforming the data based on a predetermined set of rules;
applying one or more rules to the transformed data;
generating a request for a workflow based on the transformed data and further based on a target workflow platform;
receiving a response from the target workflow platform;
determining completion of the workflow based on the response; and
transmitting an alert based on the completion of the workflow.

12. The computer-implemented method of claim 11, further comprising logging the completed workflow based on the completion of the workflow.

13. The computer-implemented method of claim 11, further comprising authenticating the generated request based on the predetermined ID.

14. The computer-implemented method of claim 11, wherein the predetermined ID is associated with a format defined in a configuration file.

15. The computer-implemented method of claim 11, wherein the document further includes an image.

16. The computer-implemented method of claim 15, further comprising:
extracting the image; and
compressing the image without reducing a quality of the image.

17. The computer-implemented method of claim 11, further comprising:
determining that the content includes a recipient address, a sender address, a subject, a date received, and/or a time received,
wherein the generated request for the workflow is further based on the recipient address, the sender address, the subject, the date received, and/or the time received.

18. The computer-implemented method of claim 11, further comprising storing third-party API credentials and endpoints.

19. The computer-implemented method of claim 11, further comprising performing the transforming as parallel threads.

20. A non-transitory computer-readable storage medium storing a program for causing a computer to execute a computer-implemented method of intake transformation, the method comprising:
accessing a document, wherein the document includes data, wherein the data includes content, metadata, and a predetermined ID;
extracting data based on parsing;
transforming the data based on a predetermined set of rules;
applying one or more rules to the transformed data;
generating a request for a workflow based on the transformed data and further based on a target workflow platform;
receiving a response from the target workflow platform;
determining completion of the workflow based on the response; and
transmitting an alert based on the completion of the workflow.
